(19) United States
(12) Patent Application Publication
(10) Pub. No.: US 2012/0264474 A1
(43) Pub. Date: Oct. 18, 2012

(54) COMMUNICATION METHOD AND WIRELESS DEVICE

(75) Inventors: Hanjin JOH, Seoul (KR); Ji Uk MOON, Seoul (KR)

(73) Assignee: PANTECH CO., LTD., Seoul (KR)

(21) Appl. No.: 13/445,279

(22) Filed: Apr. 12, 2012

(30) Foreign Application Priority Data
Apr. 14, 2011 (KR) 10-2011-0034530

(51) Int. Cl. H04W 88/12; H04W 52/02; H04W 84/12

(52) U.S. Cl. 455/517

(57) ABSTRACT

A method for automatically providing wireless Access Point (AP) includes determining whether to operate a first wireless device in an AP mode, receiving a switch request message from a second wireless device, switching the first wireless device to the AP mode, and starting a switch timer. A first wireless device to provide a wireless AP includes a transceiver to receive a switch request message from the second wireless device, and a processor to determine whether to operate the first wireless device in the AP mode in response to the switch request message and to switch the first wireless device to the AP mode.

### CROSS-REFERENCE TO RELATED APPLICATION

This application claims priority from and the benefit under 35 U.S.C. §119(a) of a Korean Patent Application No. 10-2011-0034530, filed on Apr. 14, 2011, the entire disclosure of which is incorporated herein by reference for all purposes.

### BACKGROUND

1. Field

The following description relates to wireless communication, and more particularly, to a communication device and a method for a cooperative operation between a plurality of wireless devices.

2. Discussion of the Background

With the recent development of information communication technology, a variety is of wireless communication techniques have been developed. Among the various wireless communication techniques, a Wireless Local Area Network (WLAN) may refer to a technology for wirelessly accessing the Internet from various locations (e.g., homes, companies, or specific service providing areas) by using portable terminals. In an example, portable terminals may include, without limitation, a Personal Digital Assistant (PDA), a laptop computer, and a Portable Multimedia Player (PMP). The WLAN may be based on radio frequency technology.

A lot of standardization tasks are being performed since Institute of Electrical and Electronics Engineering (IEEE) 802 (i.e., the standardization organization of WLAN technology) was established on February 1980.

WLAN technology initially supported up to 1 to 2 megabit per second (Mbps) speed through frequency hopping, band spreading, and/or infrared communication by using a frequency of 2.4 gigahertz (GHz) according to IEEE 802.11. Since then WLAN technology has advanced to support up to a speed of 54 Mbps by using Orthogonal Frequency Division Multiplexing (OFDM). In addition, in IEEE 802.11, standardizations for various technologies, such as the improvement of Quality of Service (QoS), Access Point (AP) protocol compatibility, security enhancement, radio resource measurement, wireless access vehicular environments, fast roaming, a mesh network, inter-working with an external network, and wireless network management, are being put to practical use and developed.

Furthermore, in order to overcome limitations to the communication speed of the WLAN technology, an IEEE 802.11n standard has been established as a technological standard. An object of the IEEE 802.11n standard may be to increase the speed and reliability of a wireless network and to extend the wireless coverage of the wireless network. More particularly, the IEEE 802.11n standard may be used to support at least one of a High Throughput (HT) transfer speeds, which may have a data processing speed of 540 Mbps or higher, a reduction of error in transmission, and an improvement in the data rate. Further, IEEE 802.11n may be based on Multiple Input and Multiple Output (MIMO) technology using multiple antennas on both sides of a transmitter and a receiver.

Wireless devices, to which the WLAN is applied, such as smart phones and tablet personal computers (PCs), are being diversified. Furthermore, a process referred to as tethering, in which a wireless device may provide wireless Internet access to other wireless devices by operating as a wireless modem, is introduced.

More specifically, tethering may refer to an operation in which a wireless device can be utilized as a wireless modem (or a wireless AP). For example, if a mobile phone is set as a wireless AP, a tablet PC can access the Internet service through a mobile phone operating as the wireless AP.

In general, tethering may utilize a mobile communication network, such as a 3G network or other similar networks. However, the mobile communication network may support a slower transfer speed than the WLAN, but may access the Internet in areas where mobile phone service may be provided.

As a cooperative operation between wireless devices becomes more active over a wireless network, such as tethering, it may be beneficial to reduce the battery consumption of a wireless device that operates as a wireless modem while facilitating the cooperative operation between the wireless devices.

### SUMMARY

Exemplary embodiments of the present invention provide a communication device and a method for a cooperative operation between a plurality of wireless devices.

Additional features of the invention will be set forth in the description which follows, and in part will be apparent from the description, or may be learned by practice of the invention.

Exemplary embodiments of the present invention provide a method for automatically providing a wireless Access Point (AP) including determining whether to operate a first wireless device in an AP mode, receiving a switch request message from a second wireless device, switching the first wireless device to the AP mode, and starting a switch timer.

Exemplary embodiments of the present invention provide a first wireless device to provide a wireless AP including a transceiver to receive a switch request message from a second wireless device; and a processor to determine whether to operate the first wireless device in an AP mode in response to the switch request message, and to switch the first wireless device to the AP mode.

Exemplary embodiments of the present invention provide a method for automatically providing a wireless AP including operating the first wireless device in a PSM, sharing Service Set Identifiers (SSID) between a first wireless device and a second wireless device, determining whether to operate the first wireless device in an AP mode based signal strength of a Wireless Local Area Network (WLAN) accessed by the second wireless device, receiving a switch request message from the second wireless device, switching the first wireless device to the AP mode in response to the switch request message, and determining whether to switch back to the PSM by the first wireless device based on a communication between the first wireless device and the second wireless device.

It is to be understood that both the foregoing general description and the following is detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompany drawings, which are included to provide a further understanding of the invention and constitute a part of this specification, illustrate embodiments of the invention, and together with the description serve to explain the principles of the invention.

FIG. 1 illustrates a cooperative operation between wireless devices according to an exemplary embodiment of the invention.

FIG. 2 is a flowchart illustrating a method for communicating between wireless devices according to an exemplary embodiment of the invention.

FIG. 3 illustrates a Power Save Mode (PSM) period according to an exemplary embodiment of the invention.

FIG. 4 is a flowchart illustrating a method for operating a wireless device according to an exemplary embodiment of the invention.

FIG. 5 is a block diagram illustrating a wireless device configuration according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to is the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

A mobile communication network may be implemented using wireless technology, such as standards described in Institute of Electrical and Electronics Engineers (IEEE) 802.11 (Wi-Fi), IEEE 802.16 (WiMAX), IEEE 802.20, Universal Terrestrial Radio Access (UTRA), and Evolved UTRA (E-UTRA). IEEE 802.16m may refer to an evolution of IEEE 802.16e, and it may provide backward compatibility with a system based on IEEE 802.16e. UTRA may be a part of a Universal Mobile Telecommunications System (UMTS). 3rd Generation Partnership Project (3GPP) Long Term Evolution (LTE) may be a part of Evolved UMTS (E-UMTS) using Evolved-UMTS Terrestrial Radio Access (E-UTRA), and it may adopt OFDMA in downlink and SC-FDMA in uplink. LTE-Advanced (A) may refer to an evolution of 3GPP LTE technology.

A wireless device may be fixed or mobile. The wireless device may be called another terminology, such as a mobile phone, a smart phone, a tablet PC, a Mobile Station (MS), a Mobile Terminal (MT), a User Terminal (UT), a Subscriber Station (SS), a Personal Digital Assistant (PDA), a Spread Spectrum (SS) modem, or a handheld device.

The wireless device may include a Medium Access Control (MAC) and a physical layer interface, which may comply with the guidelines of the IEEE 802.11 standard. In a broad sense, the wireless device may include both an Access Point (AP) and a non-AP station.

An AP may refer to a medium that allows a wireless device to provide Internet access to a wireless device connected to the AP.

In a WLAN system, one AP and a wireless device connected to the AP may provide a Basic Service Set (BSS). The BSS may refer to a set of wireless devices, which may be synchronized with each other and are able to communicate with each other. An identifier for identifying a BSS (or an AP within the BSS) is called a Service Set Identifier (SSID).

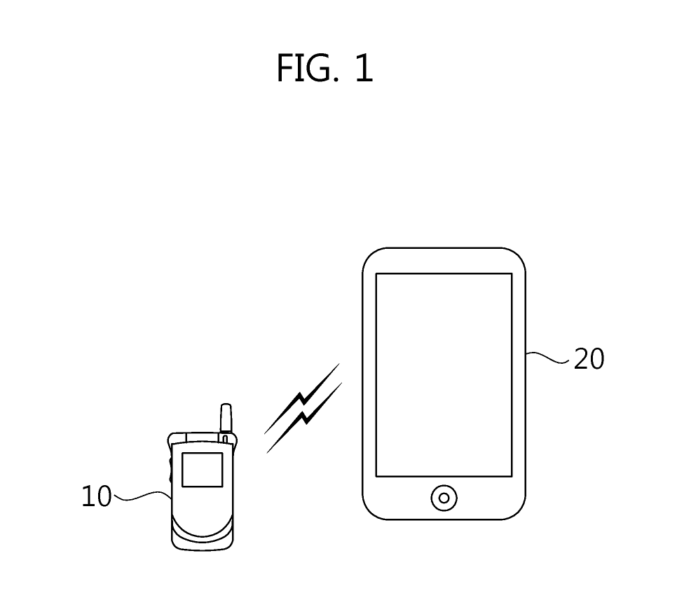

FIG. 1 illustrates a cooperative operation between wireless devices according to an exemplary embodiment of the invention.

In an example, a mobile phone 10 may access the Internet over a mobile communication network and a tablet PC 20 may access the Internet over a WLAN.

The WLAN may have a coverage range of 5 to 10 meters from an AP of the WLAN. For devices falling outside of the coverage range may receive lower data transfer speeds in comparison to data transfer speeds of devices located within the WLAN range. Accordingly, if the tablet PC 20 is positioned outside from the range of the AP (not shown) or the tablet PC 20 moves further away from the AP, service quality may be lowered or unable to be received.

In order to provide greater mobility and maintain access to the Internet, the mobile phone 10 may be utilized as a wireless AP. That is, if the mobile phone 10 supports an operation of the wireless AP and such operation of the mobile phone 10 is activated, the tablet PC 20 can maintain access to the Internet through the wireless AP operation of the mobile phone 10. This process may be commonly referred to as tethering.

According to the prior art, a user may manually activate the wireless AP operation is of the mobile terminal. However, a scheme in which the mobile phone 10 automatically activates its wireless AP operation has not yet been disclosed.

One of the reasons why the wireless AP operation of the mobile phone may not always be activated may be attributed to the battery consumption associated with the continued wireless AP operation.

A method for providing a WLAN service while reducing the battery consumption of a wireless device may be described below.

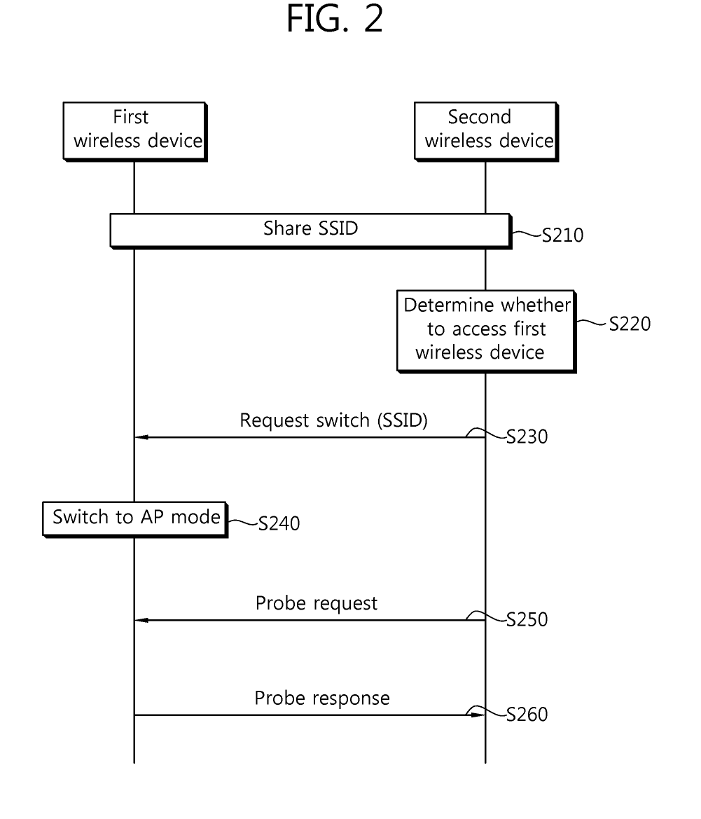

FIG. 2 is a flowchart illustrating a method for communicating between wireless devices according to an exemplary embodiment of the invention.

Referring to FIG. 2, both a first wireless device and a second wireless device may support a WLAN based on the IEEE 802.11 standard. The first wireless device may provide a wireless AP operation. Further, the first wireless device can support a mobile communication network.

The SSID of the first wireless device may also be shared by both the first and the second wireless devices at step S210. The SSID may refer to an identifier to enable the first wireless device, which may provide the wireless AP operation, to be identified by the second wireless device.

If the second wireless device has accessed the first wireless device before, the second wireless device may store the SSID. Alternatively, a user may manually store the SSID of the first wireless device in the second wireless device. The second wireless device may also receive the SSID included in a beacon frame transmitted by the first wireless device.

The first wireless device may operate in a Power Save Mode (PSM). The PSM may refer to a low power operating mode. The first wireless device operating in the PSM may periodically awaken according to a PSM period.

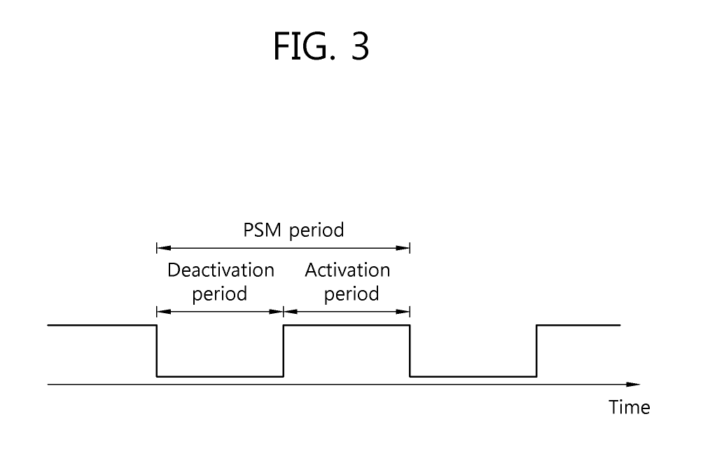

FIG. 3 illustrates a PSM period according to an exemplary embodiment of the invention.

As shown in FIG. 3, the PSM period includes a deactivation period and an activation period. During the activation period, the first wireless device can transmit or receive a radio signal. The first wireless device during the activation period may be in an activation mode. During the deactivation period, the first wireless device can receive a radio signal or perform minimum operation. The first wireless device during the deactivation period may be in a deactivation mode.

The PSM may refer to a mode used in order to distinguish the PSM from an AP mode to be described later. In the PSM, the first wireless device can access the Internet over a mobile communication network, such as a 3G network, or perform a call. At this time, the activation period may continue. The PSM may further refer to a mode in which the first wireless device does not perform the operation of the wireless AP.

Referring back to FIG. 2, the second wireless device determines whether to access the first wireless device at step S220. For example, if a signal strength of the existing accessed WLAN is determined to be weak or below a reference threshold, the second wireless device may determine to access the first wireless device. Further, the second wireless device may also determine to access the first wireless device according to a user's command. Further, if a location or a position of the second wireless device corresponds to a reference location or position or is outside of a specified distance range from a reference device as determined by a Global Positioning System (GPS) signal, the second wireless device may determine to access the first wireless device.

If access to the first wireless device is determined, the second wireless device transmits a switch request message to the first wireless device at step S230. The switch request message may refer to a message that requests the first wireless device to switch from the PSM to the AP mode. In addition, the switch request message may be a message that requests the first wireless device to activate a wireless AP operation.

The AP mode may refer to a mode in which the first wireless device provides the operation of the wireless AP. In the AP mode, the first wireless device may be awakened, and the first wireless device allows the second wireless device or other wireless devices to access thereto. In the AP mode, other wireless devices can be provided with Internet service through the first wireless device.

The second wireless device may transmit the switch request message to the first wireless device during a reference period or if a reference condition is satisfied. Here, the reference condition may refer to a state in which the intensity of a received signal is weaker than reference intensity. Further, the reference condition may refer to at least one of a condition according to a user command or GPS position information, as described above.

In the activation period of the PSM, the first wireless device can receive the switch request message. Accordingly, if the transmission period of the switch request message does not correspond with the activation period, access to the second wireless device may be delayed. In order to reduce the likelihood of this delay, the second wireless device may store information about the PSM period of the first wireless device in advance. The second wireless device can transmit the switch request message to the first wireless device according to the previously stored PSM period.

The switch request message may include Information Elements (IEs), such as that is shown in Table 1 below.

TABLE 1

| Name | Description |
|---|---|
| SSID | SSID of wireless AP requested to switch to AP mode |
| HT Throughput | Information about IEEE 802.11n support capabilities of a |
| Capabilities | wireless device transmitting a switch request |

The switch request message may be a message of a new format, or a probe request message defined in the IEEE 802.11 standard may be used as the switch request message.

If the switch request is received, the first wireless device can inform a user that a switch to the AP mode will be made.

If the remaining battery capacity is smaller than a reference capacity or if the first device is unable to switch to the AP mode, the first wireless device may reject the switch to the AP mode. If the switch to the AP mode is rejected, the first wireless device may transmit a signal to reject the switch to the second wireless device (not shown). The switch reject may include an SSID.

In response to the switch request, the first wireless device switches to the AP mode to allow the second wireless device to access the first wireless device at step S240. The first wireless device may inform the user of the switch to the AP mode.

The second wireless device transmits a probe request to the first wireless device at step S250. In response to the probe request, the first wireless device transmits a probe response to the second wireless device at step S260. Accordingly, the first wireless device and the second wireless device may communicate with each other.

Further, the first wireless device may inform the switch to the AP mode by is transmitting a beacon frame without exchanging a probe request and/or a probe response. The second wireless device that has received the beacon frame can attempt to access the first wireless device.

According to the conventional practice, the first wireless device may not automatically switch to the AP mode, and a user may manually switch to the AP mode. According to exemplary embodiments of the present invention, however, the first wireless device in the PSM period may automatically switch to the AP mode in response to the switch request of the second wireless device. Accordingly, although a connection with the existing WLAN may be disconnected, the second wireless device can automatically access a new AP, and may be capable of providing Internet service in areas outside of the WLAN.

The first wireless device standing in the PSM may switch from the PSM to the AP mode at the request of the second wireless device.

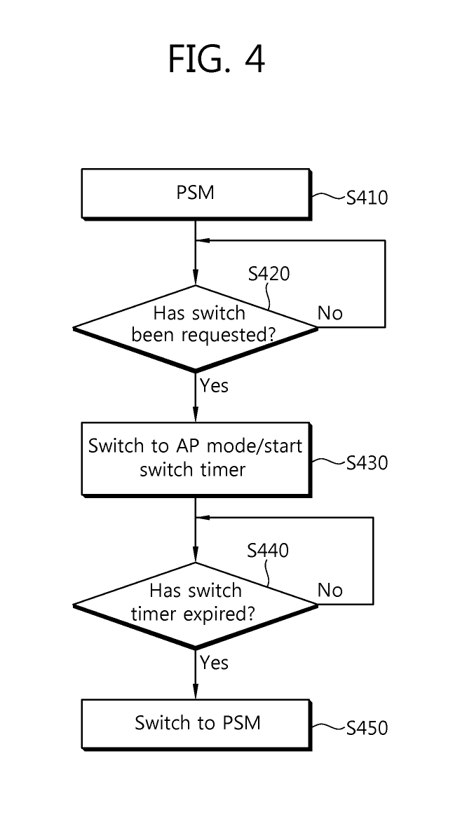

FIG. 4 is a flowchart illustrating a method for operating a wireless device according to an exemplary embodiment of the invention.

The method of FIG. 4 below will be described as if performed by the first wireless device as shown in FIG. 2, but is not limited as such.

The first wireless device operates in the PSM at step S410.

If a switch request is received from the second wireless device at step S420, the first wireless device switches to the AP mode at step S430 and starts a switch timer.

The first wireless device determines whether the switch timer has expired at step S440. The switch timer may be restarted if communication between the first wireless device and the second wireless device is performed. For example, if the first wireless device transmits a message to the second wireless device or the first wireless device receives a message from the is second wireless device, the switch timer may be restarted.

If, as a result of the determination, the switch timer has expired, the first wireless device switches to the PSM at step S450.

If communication between the first wireless device and the second wireless device is not performed for a specific period of time, the first wireless device may switch to the PSM to reduce the battery consumption. The first wireless device may inform a user of the switch to the PSM.

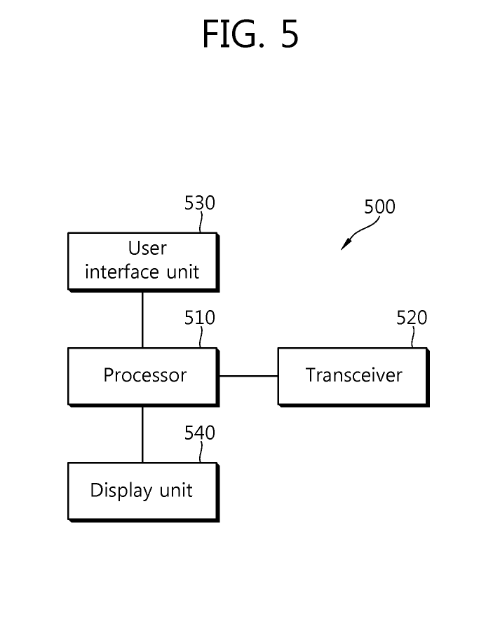

FIG. 5 is a block diagram illustrating a wireless device configuration according to an exemplary embodiment of the invention.

The wireless device 500 may be the first wireless device or the second wireless device described in FIG. 2 or FIG. 4, but is not limited thereto.

As shown in FIG. 5, the wireless device 500 includes a processor 510, a transceiver 520, a user interface unit 530, and a display unit 540.

The processor 510 may implement the operation of the first wireless device or the second wireless device described in FIG. 2 or FIG. 4, but is not limited thereto.

The transceiver 520 transmits and receives messages to and from other wireless devices using a wireless medium. The user interface unit 530 may be formed of a conventional user interface or a combination of well-known user interfaces, such as a keypad or a touch screen. The display unit 540 may display various pieces of information of the wireless device, by using well-known display technologies, such as a Liquid Crystal Display (LCD), Organic Light Emitting Diodes (OLEDs), and the like.

The processor may include, without limitation, at least one of an Application-Specific Integrated Circuits (ASICs), other chipsets, logic circuits and data processing devices. If the embodiment is implemented in software, the above scheme may be implemented using one or more modules to perform the above operations.

As described above, a wireless device can automatically switch to the AP mode, so that access to the Internet can be maintained if Internet provided by WLAN may be unavailable or not preferred. Furthermore, the battery consumption of a wireless device performing a wireless AP operation can be reduced because the wireless device switches to the AP mode in response to a request by another wireless device rather than performing the respective operation if no such requests are received.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for automatically providing a wireless Access Point (AP) performed by a first wireless device, the method comprising:
determining whether to operate the first wireless device in an AP mode;
receiving a switch request message from a second wireless device;
switching the first wireless device to the AP mode; and
starting a switch timer.

2. The method of claim 1, wherein the determination of whether to operate the first wireless device in the AP mode is based on signal strength of a Wireless Local Area Network (WLAN) accessed by the second wireless device.

3. The method of claim 2, wherein the first wireless device determines to operate in the AP mode in response to a determination that the signal strength of the accessed WLAN is below a reference threshold.

4. The method of claim 1, wherein the determination of whether to operate the first wireless device in the AP mode is based on a determination of a location of the second wireless device.

5. The method of claim 1, wherein the switch request message comprises a message requesting the first wireless device to switch from a Power Saving Mode (PSM) to the AP mode, the AP mode being a mode of the first wireless device in an awakened mode providing the wireless AP.

6. The method of claim 5, wherein the PSM comprises a PSM period comprising an activation period and a deactivation period.

7. The method of claim 6, wherein the first wireless device informs a second device of the switch to the AP mode by transmitting a beacon frame.

8. The method of claim 1, further comprising:
receiving a probe request from the second wireless device; and
transmitting a probe response to the second wireless device.

9. The method of claim 1, further comprising:
operating the first wireless device in a PSM;
starting a switch timer in response to switching to the AP mode; and
determining whether the switch timer expired.

10. The method of claim 9, wherein the switch timer is restarted if communication between the first wireless device and the second wireless device is performed.

11. The method of claim 9, wherein the switch request message comprises a message requesting the first wireless device to activate a wireless AP operation.

12. The method of claim 1, wherein the first wireless device and the second wireless identify each other by Service Set Identifiers (SSID).

13. A first wireless device to provide a wireless Access Point (AP), comprising:
a transceiver to receive a switch request message from a second wireless device; and
a processor to determine whether to operate the first wireless device in an AP mode in response to the switch request message, and to switch the first wireless device to the AP mode.

14. The first wireless device of claim 13, wherein the processor determines whether to operate the first wireless device in the AP mode based on signal strength of a Wireless Local Area Network (WLAN) accessed by the second wireless device.

15. The first wireless device of claim 14, wherein the first wireless device determines to operate in the AP mode in response to a determination that the signal strength of the accessed WLAN is below a reference threshold.

16. The first wireless device of claim 13, wherein the determination of whether to operate the first wireless device in the AP mode is based on a determination of a location of the second wireless device.

17. The first wireless device of claim 13, wherein the switch request message comprises a message requesting the first wireless device to switch from a Power Saving Mode (PSM) to the AP mode, the AP mode being a mode of the first wireless device in an awakened mode providing the wireless AP.

18. The first wireless device of claim 13, wherein the transceiver further receives a probe request from the second wireless device and transmits a probe response to the second wireless device.

19. The first wireless device of claim 13, wherein the processor further operates the first wireless device in a PSM, starts a switch timer in response to switching to the AP mode, and determines whether the switch timer expired.

20. A method for automatically providing a wireless Access Point (AP) performed by a first wireless device, the method comprising:
operating the first wireless device in a Power saving Mode (PSM);
transmitting a Service Set Identifier (SSID) of the first wireless device to a second wireless device;
determining whether to operate the first wireless device in an AP mode based on signal strength of a Wireless Local Area Network (WLAN) accessed by the second wireless device;
receiving a switch request message from the second wireless device;
switching the first wireless device to the AP mode in response to the switch request message; and
determining whether to switch back to the PSM by the first wireless device based on a communication between the first wireless device and the second wireless device.
